(19) United States
(12) Patent Application Publication
(10) Pub. No.: US 2007/0102249 A1
(43) Pub. Date: May 10, 2007

(54) Automatically locking parking brake for a vehicle

(76) Inventors: Peter Ullmann, Burgberg (DE); Christoph Kasper, Sonthofen (DE); Cedric Leboisne, Le Perreux sur Marne (FR)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/523,036

(22) Filed: Sep. 19, 2006

(30) Foreign Application Priority Data
Sep. 19, 2005 (DE) 10 2005 044 669.8

(51) Int. Cl. F16D 55/08

(52) U.S. Cl. 188/72.7

(57) ABSTRACT

A parking brake for a vehicle, including a parking brake unit, a drive unit, an actuating device situated between the parking brake unit and the drive unit, which actuating device is drivable by the drive unit and actuates the parking brake unit, and a mechanical locking device situated between the drive unit and the actuating device, which locking device, when a drive torque is interrupted, automatically locks the actuating device in order to mechanically lock the parking brake unit in a braking position; the locking occurs by means of a counteracting torque, which acts on the locking device after the interruption of the drive torque.

### CROSS REFERENCE TO RELATED APPLICATIONS

This application is based on German Patent Application No. 10 2005 044 669.8 filed 19 Sep. 2005, upon which priority is claimed.

### BACKGROUND OF THE INVENTION

1. Field of the Invention

The invention relates to a parking brake for a vehicle, with automatic locking of a parking brake position.

2. Description of the Prior Art

A wide variety of parking brake (hand brake) designs are known from the prior art. Most recently, the known cable-operated brake, which includes a brake cable for engaging the parking brake by means of a hand brake lever inside the vehicle, is being increasingly replaced by automated parking brakes. With the automated parking brakes, a switch or button, for example, is provided inside the vehicle and, when actuated by a driver, sends a corresponding signal to a control unit, which triggers a drive unit in order to engage the parking brake. In this connection, so-called cable pullers are known, in which an electric motor actuates a remaining cable by means of a spindle unit with self-locking thread. The self-locking thread is necessary in order to maintain the braking position of the parking brake. Parking brakes of this kind, however, suffer from the disadvantage of poor efficiency due to the presence of the self-locking thread. For this reason, the drive unit must be relatively large, as a result of which, the drive unit takes up a relatively large amount of space.

### OBJECT AND SUMMARY OF THE INVENTION

The parking brake for a vehicle according to the present invention has the advantage over the prior art of making it possible to eliminate a self-locking thread. A drive unit for actuating the parking brake, for example an electric motor, can thus be embodied in a small form. In addition, an efficiency of the parking brake can be significantly improved so that less energy is required to immobilize a vehicle. The parking brake according to the present invention has a locking device that executes an automatic locking when an interruption in the drive torque of the drive unit occurs. According to the present invention, a counteracting torque that works in opposition to the drive torque is used to execute the mechanical locking of the parking brake position.

Preferably, the locking device includes a housing, at least one rolling element, an input element connected to the drive unit, and a driven element connected to the actuating device of the parking brake; to lock, the rolling element can be clamped between a tapering region and the housing of the locking device. Consequently, according to the present invention, the inclination of the tapering region is used to clamp the rolling element between the tapering region and the housing, which assures the mechanical locking.

In order to have the smallest possible number of parts, the tapering region is preferably provided on the actuating device.

The actuating device preferably includes a screw link actuator with a nut and a spindle; the tapering region and the driven element are situated on a wavy extension of the spindle. The tapering region is preferably situated at the outer circumference of the wavy extension. The tapering region and the driven element are consequently integrated into the actuating device, thus making it possible to keep the number of parts to a minimum and to achieve a particularly compact, simple design.

Preferably, the wavy extension of the spindle is provided with three tapering regions and three driven elements. The tapering regions here are preferably situated directly adjacent to the driven elements and preferably arranged uniformly along the circumference of the wavy extension.

Preferably, a rolling element is situated in the circumferential direction between an input element and a driven element of the locking device.

In order to use a drive unit, e.g. an electric motor, that is as inexpensive as possible, preferably a transmission, in particular a planetary gear, is provided between the drive unit and the actuating device.

The locking device also preferably includes a retaining plate that can be driven by the drive unit. One or more input elements are situated on the retaining plate. The input elements are preferably elements that protrude in the axial direction.

The parking brake according to the present invention is particularly preferably used in connection with cable pullers.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a schematic sectional view of a locking device for a parking brake according to one exemplary embodiment of the present invention,

FIG. 2 is a schematic sectional view along the line II-II from FIG. 1 when in the non-actuated state,

FIG. 3 shows the schematic sectional view from FIG. 2 when the parking brake is being actuated,

FIG. 4 is an enlarged partial detail view from FIG. 3,

FIG. 5 shows the sectional view from FIG. 2 during the locking procedure of the parking brake, and

FIG. 6 shows an enlarged partial view from FIG. 5.

### DESCRIPTION OF THE PREFERRED EMBODIMENTS

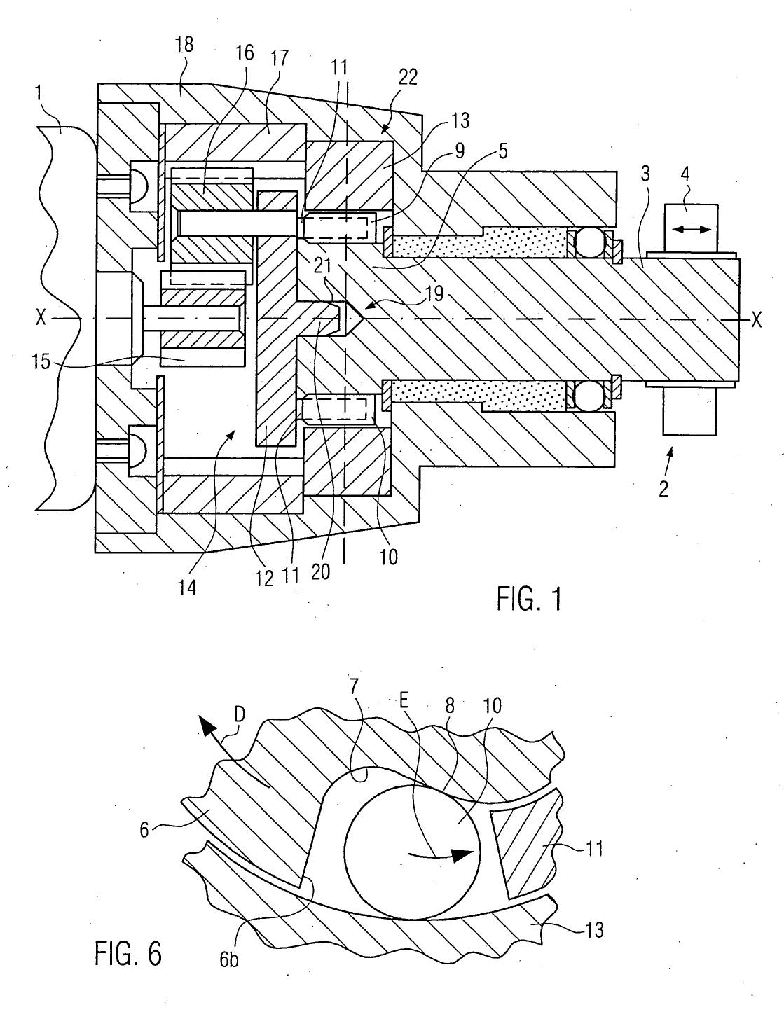

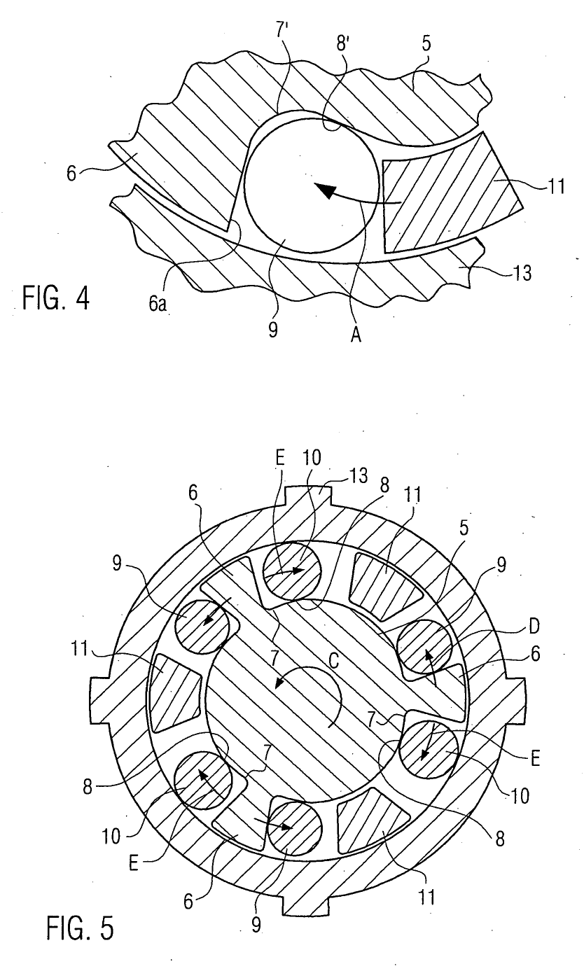

An exemplary embodiment of the present invention will be described in detail below in conjunction with FIGS. 1 through 6.

As is clear from FIG. 1, the parking brake includes a drive unit 1, which is embodied in the form of an electric motor. In addition, the parking brake includes an actuating device 2 for actuating a parking brake unit (not shown). The actuating device 2 has a screw link actuator including a spindle 3 and a nut 4 as well as a brake cable (not shown), which is attached to the nut 4. The screw link actuator converts a rotary motion of the spindle 3 into a translatory motion of the nut 4 so that the nut 4 can exert a tensile force on the brake cable, which brings the parking brake unit into its braking position.

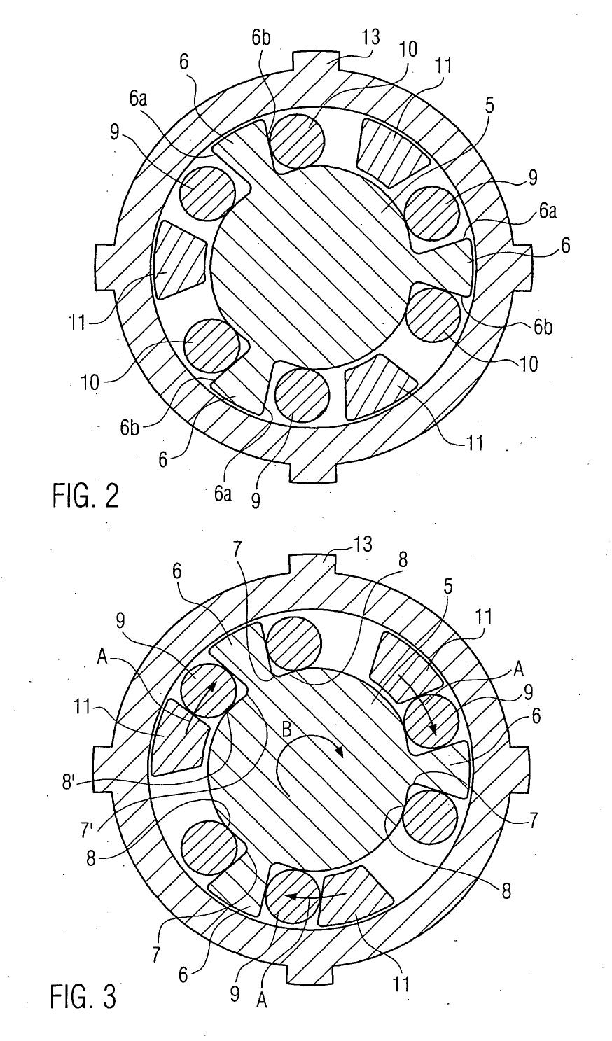

A locking device 22 and a transmission 14 are provided between the drive unit 1 and the actuating device 2. The transmission 14 is a planetary gear and has a sun gear 15, a planet gear 16, and an outer ring gear 17. The outer ring gear 17 is situated in stationary fashion in a housing 18 of the parking brake. The drive unit 1 drives the sun gear 15. As a planet gear support of the planet gear 16, a retaining plate 12 is provided, which rotates together with the planet gear around the sun gear 15. As is clear from FIG. 1, the retaining plate 12 is supported on a bearing 19. The bearing 19 includes a bearing pin 20 that is integrally joined to the retaining plate 12. The bearing pin 20 is supported in rotary fashion in a bore 19; the bore 19 is provided in a wavy extension 5 of the spindle 3. The support of the retaining plate 12 in the wavy extension 5 of the spindle 3 also permits a particularly compact design in the axial direction X-X. As is clear from the sectional view in FIG. 2, the wavy extension 5 is embodied as integrally joined to three driven elements 6. The driven elements 6 protrude radially out from the wavy extension 5 and are spaced apart from one another by an angular spacing of 120°. The driven elements 6 are trapezoidal and have lateral contact surfaces 6a and 6b. As is clear from FIG. 6, a recess 7 is provided next to the contact surface 6b in the wavy extension 5. The recess 7 has a tapering region 8. In the same manner as the contact surface 6b, the contact surface 6a also has a recess 7′ adjacent to it, with a tapering region 8′.

As is also clear from FIGS. 1 and 2, the retaining plate 12 has three input elements 11, which are likewise spaced apart from one another by an angular spacing of 120° along the circumference of the retaining plate. As is clear from FIG. 1, the input elements 11 protrude toward the wavy extension 5, in the axial direction X-X. The input elements 11 are likewise embodied as essentially trapezoidal. Between each input element 11 and each driven element 6, a respective rolling element 9 is provided for torque transmission in the circumferential direction. In addition, a locking element 10 is provided between each driven element 6 and each input element 11. The locking element 10 is likewise embodied in the form of a rolling element. For example, the rolling elements can be embodied in the form of balls or cylinders.

The function of the parking brake according to the present invention will be described in detail below. When a desire to engage the parking brake is signaled through actuation of a button or the like inside the vehicle, this signal is transmitted to a control unit. The control unit transmits a corresponding signal to the drive unit 1 in order to actuate it. The drive unit 1 drives the retaining plate 12 via the transmission 14. FIG. 2 shows the initial position of the retaining plate 12, in which the input elements 11 of the retaining plate 12 are spaced slightly apart from the torque-transmitting rolling elements 9. When the retaining plate 12 is driven, the input elements 11 rotate, as shown in FIG. 3, in the direction of the arrows A. As a result, first the retaining plate 12 and the input elements 11 move in relation to the wavy extension 5 with the driven elements 6. The input elements 11 come into contact with the torque-transmitting rolling elements 9 and the rolling elements 9 are pressed against the driven elements 6 of the wavy extension. This permits a torque to be transmitted from the retaining plate 12 to the wavy extension 5 via the input elements 11, the rolling elements 9, and the driven elements 6 so that the wavy extension 5 rotates in the direction of the arrow B. This causes the spindle 3 to start to rotate and the non-rotatably situated nut 4 can be used to exert translatory motion for actuating the brake cable, which is not shown. This switches the parking brake into its braking position.

When the parking brake is engaged, which can be detected, for example, by a sensor, the control unit switches the drive unit 1 off. This interrupts the transmission of the drive torque from the retaining plate 12 to the wavy extension 5. As a result of the sudden elimination of the drive torque, the component stresses, in particular stresses in the cable, cause the torque transmission to generate a counteracting torque so that the wavy extension 5 rotates slightly in the direction of the arrow C, counter to the direction of the drive torque. This slight rotation of the wavy extension 5 causes the locking elements 10 to roll along the wavy extension 5 in the direction of the arrow E and thus to roll along the tapering region 8 of the recess 7. FIG. 6 shows an enlarged view of this. As a result, the locking elements 10 are clamped between the wavy extension 5, or more precisely stated, the tapering region 8, and the housing 13 of the locking device 22. This assures an automatic mechanical locking of the parking brake in the braking position. The driven elements 6 also move the rolling elements 9 in the direction of the arrow D.

In order to avoid damage to the locking device 22, all components of the locking device 22 are preferably made of metal.

It should be noted that for example, a spring element or the like can also assist in generating the counteracting torque. It should also be noted that even if the counteracting torque were not to occur after interruption of the drive torque, the parking brake position would still be assured since if the parking brake is released somewhat, then the screw link actuator rotates the wavy extension 5 in the direction of the arrow C and then the clamping elements 9 are immediately clamped between the tapering region 8 and the housing 13.

Since the recess 7 with the tapering region 8 is relatively small, a rotation of the wavy extension 5 by a few millimeters is sufficient to automatically lock the locking device 22 according to the present invention.

The present invention thus makes it possible to create a particularly compact and simply designed locking device. The locking device thus functions automatically. Consequently, the present invention makes it possible to eliminate an additional actuator for actuating the locking device. It is thus possible on the whole to produce a particularly compact, small parking brake. In addition, it is not necessary to use a self-locking transmission for the screw link actuator, thus also permitting a drive unit 1 to be small in size.

The foregoing relates to preferred exemplary embodiments of the invention, it being understood that other variants and embodiments thereof are possible within the spirit and scope of the invention, the latter being defined by the appended claims.

We claim:

1. In a parking brake for a vehicle, including a parking brake unit, a drive unit, an actuating device situated between the parking brake unit and the drive unit, which actuating device is drivable by the drive unit and actuates the parking brake unit, and a mechanical locking device situated between the drive unit and the actuating device, which locking device, when a drive torque is interrupted, automatically locks the actuating device in order to mechanically lock the parking brake unit in a braking position, the improvement comprising means for applying a counteracting torque to lock the locking device which counteracting torque acts on the locking device after the interruption of the drive torque.

2. The parking brake according to claim 1, wherein the locking device comprises a housing, at least one locking element, an input element connected to the drive unit, and a driven element connected to the actuating device, and wherein in order to lock the parking brake position, the locking element is clamped between the housing and a tapering region on the driven element.

3. The parking brake according to claim 2, wherein the tapering region is provided on the actuating device.

4. The parking brake according to claim 3, wherein the actuating device comprises a screw link actuator with a nut and a spindle including a wavy extension, wherein the tapering region, and wherein the driven element are situated on the wavy extension and the tapering region is provided on the outer circumference of the wavy extension.

5. The parking brake according to claim 2, further comprising a respective torque-transmitting rolling element between each input element and driven element.

6. The parking brake according to claim 3, further comprising a respective torque-transmitting rolling element between each input element and driven element.

7. The parking brake according to claim 4, further comprising a respective torque-transmitting rolling element between each input element and driven element.

8. The parking brake according to claim 1, further comprising a planetary gear transmission between the drive unit and the locking device.

9. The parking brake according to claim 2, further comprising a planetary gear transmission between the drive unit and the locking device.

10. The parking brake according to claim 3, further comprising a planetary gear transmission between the drive unit and the locking device.

11. The parking brake according to claim 4, further comprising a planetary gear transmission between the drive unit and the locking device.

12. The parking brake according to claim 5, further comprising a planetary gear transmission between the drive unit and the locking device.

13. The parking brake according to claim 2, wherein the input element is situated on a retaining plate and protrudes in the axial direction.

14. The parking brake according to claim 3, wherein the input element is situated on a retaining plate and protrudes in the axial direction.

15. The parking brake according to claim 4, wherein the input element is situated on a retaining plate and protrudes in the axial direction.

16. The parking brake according to claim 5, wherein the input element is situated on a retaining plate and protrudes in the axial direction.

17. The parking brake according to claim 8, wherein the input element is situated on a retaining plate and protrudes in the axial direction.

18. The parking brake according to claim 13, wherein the retaining plate is supported in a bearing in the wavy extension.

19. The parking brake according to claim 4, wherein the actuating device comprises a brake cable situated between the parking brake unit and the screw link actuator.

20. The parking brake according to claim 13, wherein the actuating device comprises a brake cable situated between the parking brake unit and the screw link actuator.
